(19) United States
(12) Patent Application Publication
(10) Pub. No.: US 2016/0238388 A1
(43) Pub. Date: Aug. 18, 2016

(54) SOLAR SYSTEM INSTALLATION

(71) Applicant: Vivint Solar, Inc., Lehi, UT (US)

(72) Inventors: Willard S. MacDonald, Sebastopol, CA (US); Randall King, Santa Rosa, CA (US); Roger L. Jungerman, Petaluma, CA (US)

(21) Appl. No.: 15/045,484

(22) Filed: Feb. 17, 2016

Related U.S. Application Data
(60) Provisional application No. 62/117,315, filed on Feb. 17, 2015.

(51) Int. Cl. G01C 11/00; G01J 1/42; G01B 11/02; H02S 20/23

(52) U.S. Cl. CPC G01C 11/00; H02S 20/23; G01J 1/42; G01B 11/02; F24J 2002/0038

(57) ABSTRACT

The present disclosure is directed to photovoltaic installation systems and methods. A method may include determining a maximum number of photovoltaic (PV) modules for positioning on a roof of a structure, and determining one or more regions on the roof for positioning at least the maximum number of PV modules. Further, the method may include submitting a permitting package including the maximum number of PV modules and the one or more regions. In addition, the method may include determining a number of PV modules to be installed on the roof, where in the number of PV modules less than or equal to the maximum number of PV modules. The method may also include installing the number of PV modules within at least one of the one or more regions. The method may also include establishing the as-built characteristics of the PV system.

### CROSS-REFERENCE TO RELATED APPLICATIONS

This application claims the benefit of and priority to U.S. Provisional App. No. 62/117,315, filed Feb. 17, 2015, which is incorporated herein by reference.

### TECHNICAL FIELD

This disclosure relates generally to photovoltaic system, more specifically, to methods for designing and installing a photovoltaic system.

### BACKGROUND OF RELATED ART

Solar panels, which may include a set of solar photovoltaic modules, use light energy (photons) from the sun to generate electricity through the photovoltaic effect. A photovoltaic system including a plurality of solar panels and various other electrical components may be used to generate and supply electricity in commercial and residential applications.

The addition of solar panels to new and existing structures is becoming increasingly popular due to growing public awareness about energy independence, the desire to curb rising energy costs, and the increased affordability of solar panels.

### BRIEF SUMMARY

In one specific embodiment, a method may include determining a maximum number of photovoltaic (PV) modules for positioning on a roof of a structure. The method may also include determining one or more regions on the roof for positioning the maximum number of modules. Further, the method may include submitting a permitting package including the maximum number of PV modules and the one or more regions. Moreover, the method can include determining a number of modules to be installed on the roof, wherein the number of modules is less than or equal to the maximum number of modules. Furthermore, the method may include installing the number of modules within at least one of the one or more regions.

In another specific embodiment, a method can comprise receiving a permit based on a determined maximum number of PV modules to be positioned on a roof of a structure and one or more regions on the roof for positioning the maximum number of modules. The method may further include evaluating the suitability of various locations for modules within the regions. Moreover, the method may include determining a number of modules to be installed on the roof, wherein the number of modules less than or equal to the maximum number of modules. The method can also include installing the number of modules within at least one of the one or more regions.

According to another embodiment, a method may include determining a maximum number of PV modules of a PV system to be positioned on a roof of a structure. In addition, the method may include determining one or more regions on the roof for positioning the maximum number of modules. Further, the method may include determining a minimum number of PV modules for the PV system. Additionally, the method can include submitting a permitting package including the maximum number of PV modules and the one or more regions.

Furthermore, the method may include installing the PV system including a number of modules less than or equal to the maximum number of modules and greater than or equal to the minimum number of modules and within at least one of the one or more regions. Also, the method can include establishing an accurate energy forecast of the PV system after installing the PV system.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1 is a flowchart illustrating a process of installing a photovoltaic system;

FIG. 2 is a flowchart illustrating a process, according to an embodiment of the present disclosure;

FIG. 3 depicts a pole including a camera proximate a structure, according to an embodiment of the present disclosure; and

FIG. 4 illustrates a system, in accordance with an embodiment of the present disclosure.

### DETAILED DESCRIPTION

Referring in general to the accompanying drawings, various embodiments of the present disclosure are illustrated to show the structure and methods for installing a system, such as a photovoltaic system. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

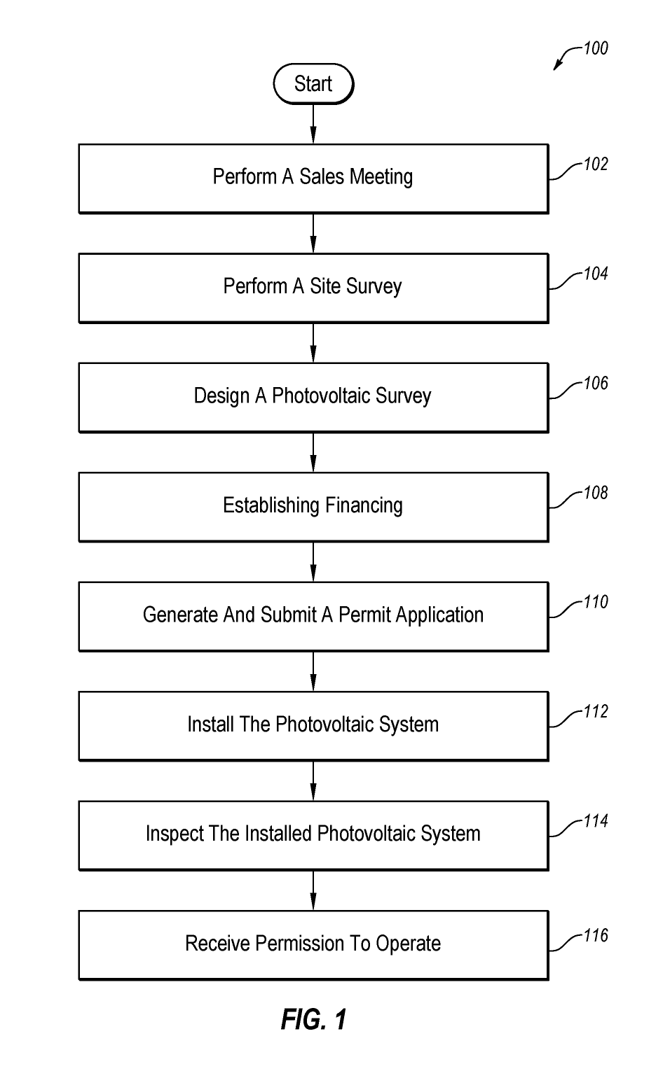

FIG. 1 is a flowchart depicting an example photovoltaic (PV) system installation process 100. Process 100 may begin with sales meeting (e.g., via an in-person sales visit, remote sales call, sales email, etc.) (depicted by act 102). During a sales meeting, a sales person may provide a potential customer with various estimates regarding a solar system (e.g., a module layout, energy production, cost, financing options, and energy savings).

After the sales meeting, a site survey may be performed (depicted by act 104). A site survey may include evaluating a roof of a structure at a property to establish the roofs viability for a solar system (i.e., physically and financially). If the roof is viable, and a sale is closed, or it is deemed a likely sale, an on-site site survey may be performed. Further, a dedicated site survey technician may visit the site. A site survey may require that an individual climb onto the roof and measure roof dimensions, orientation, shade, and the size and location of roof penetrations, such as vent pipes. The shade may be measured at a number of locations, including the corners of roof sections, using a measurement tool such as a SunEye provided by Solmetric Corp. of Sebastopol, Calif. The condition and amperage of a service panel (e.g., ability to handle additional current of inverter), condition of the roof (e.g., age), and condition of the roof structure (e.g., rafters) are also established. Sometimes a roof is rejected for a PV system due to a problem identified in the service panel, roof, or structure. Photographs of the site are often taken, including service panel, distribution panel, rafter spacing, rafter conditions, and roof conditions.

Thereafter, a detailed design of the PV system may be performed (depicted by act 106). A detailed design may be performed by a dedicated system designer. The design typically includes specifying the equipment to be installed (e.g., modules, inverters, disconnects, footings, racking, etc.), wire size and type, and the location of modules, inverter(s), conduit, and other equipment. It may also include simulation of future energy production.

Method 100 further includes establishing financing for the PV system (depicted by act 108). In larger residential installation companies, a PV system may be owned by an installer and/or by a third party financial partner, who provides the capital expenses for the installation and takes the tax benefits and/or the long-term energy revenue from a power purchase agreement (PPA) with the off-taker (i.e., the homeowner). An accurate estimate (e.g., better than 5% accuracy) of the future energy production of the PV system may be needed to determine the amount of capital financing needed. An alternative financing model includes leasing a PV system to a homeowner. A lease may include a performance guarantee. In this case, an accurate estimate of future energy production may be needed to properly set the performance guarantee. The biggest factors impacting the production, and, hence the required financing or performance guarantee, are the number of modules, the power rating of the modules, the expected insolation (i.e. weather), and the shading of one or more arrays of solar modules. If production of a PV system is not accurately predicted, it can result in increased risk or loss of profits for the installer, financing partner, or off-taker.

In addition, method 100 includes generating and filing a permit application (depicted by act 110). After future energy production is determined, a detailed set of permit drawings may be produced. These drawings may include a site plan and roof plan (i.e., showing the precise layout and location of modules on the roof), and an electrical drawing. These drawings may be submitted to a local authority for approval. A first financing tranche, for example 50%, may be released after the design is complete.

Thereafter, method 100 includes installing the PV system (depicted by act 112). The solar modules and other equipment, as described on the permit drawings, may then be installed (i.e., by an installation crew). Thereafter, a second financing tranche, for example 25%, may be released after the installation is complete. The final system design and accurate energy production forecast is completed before installation begins (i.e., because the installation must be done as specifically described in the detailed permit drawings and because the forecast is used to do the financing tranches).

After installation is complete, an inspection may be performed (e.g., by a local authority, also referred to herein as an authority having jurisdiction (AHJ), and/or a utility company) (depicted by act 114). If approved, the PV system has permission to operate (PTO), and may be turned on for operation (depicted by act 116). If the installation does not match the permit drawings, the PV system may fail the inspection and may be refused PTO. In this case, it may be necessary to change the installation or re-submit the permit application and re-do the inspection. Typically the final financing tranche is released after a PTO is granted.

Method 110 include three important costs (i.e., costs for the site survey, cost of sales lost during the site survey and permitting phases, and delayed revenue). AHJs may require that permit drawings show precise numbers and locations of modules per roof section, which means that a design and a computer-aided design (CAD) must be accurate, which, in turn, means an accurate in-person site survey must be performed. Part of a site survey may involve a technician climbing on the roof to measure dimensions, orientation, and shading of the roof. Therefore, an installation company must carry special workmen's compensation insurance (e.g., at about $2 per hour) that covers the technician climbing on the roof (e.g., compared to about $0.02/hour for workman's comp for an office worker). Climbing on the roof also requires costly and time consuming Occupational Safety and Health Administration (OSHA) safety precautions, including attaching an anchor to the roof and using a safety rope and harness. Attaching an anchor may require drilling one or more holes in a roof for attaching the anchor. The anchor may be removed and the holes patched after the roof measurements are complete. As will be understood, the cost of a site survey is substantial (e.g., $150 to $250 per site).

As will be appreciated, as much as half of the sold PV projects are cancelled in some phase before PTO. The long wait time for customers is a factor for the high cancellation rate during this time period. The typical amortized cost of cancelled projects is around $1000 per system. Further, every month of delay to the PTO is delayed revenue that is typically around $100 per month.

There are thousands of AHJs in the U.S. and each tends to dictate its own requirements for residential PV system permits. Requirements may include setbacks from roof edges for fire access, detailed descriptions of the number and position of modules and other electrical equipment including inverters and electrical disconnects. These detailed and varying requirements make permitting particularly costly for some solar companies. Expediting this process is important to reducing the “soft costs” associated with solar power.

It is also may be desirable to eliminate the need for personnel other than the installation crew to get on the roof. It has been proposed to perform a site survey using aerial imagery, such as aerial photogrammetry or aerial light detection and ranging (LIDAR), to create a 3-D model of the roof or site from which dimensions, orientation, and shade can be extracted. This method has not proven to be commercially viable due to limitations of resolution, coverage, age of data, or cost of the data.

California has recently mandated expedited solar permits by fall, 2015, including a simplified permit application and a maximum 45 day approval (rather than current 60 day). The California law requires that the AHJs “substantially conform” with the guidelines in the California Solar Permitting Guidebook, including electronic application submittal, simple structural forms not requiring licensed engineer stamp, over-the-counter applications or 1-3 day turn-around time, and inspection appointments within 5 days.

Expedited permitting as envisioned by California and others will save costs for PV system installers, however, the California law, for example, still recommends that AHJs require a site plan drawing showing the precise number and location of modules. This requires accurate site survey measurements and a detailed design and has similar complexity compared with the current process. What is needed is an accurate, low cost, reliable, and commercially viable method of designing and installing solar arrays that improves permitting and does not require personnel to get on the roof prior to the physical installation of PV system equipment.

In one embodiment of the present disclosure, an installation process may be completed without a site survey, as described above. More specifically, it may not be required to establish a specific number and location of modules prior to installation. Eliminating a need to establish the specific number of modules and the location of the modules prior to installation may lead to a profound change in a PV system installation process, and may lead to significant cost savings. In one embodiment of the present disclosure, a permit package, which may be provided to an AHJ, may not include any specific information about the solar system being proposed. In another embodiment, a permit package may include one or more of an approximate number of modules, an approximate power size (e.g., kWH), and an approximate cost of the system. In another embodiment of the present disclosure, a permit package, which may be provided to an AHJ, may include a maximum number of modules and specified regions (e.g., regions on a roof of a structure on a property) where modules may be installed. The specified regions may adhere to all code requirements, such as setbacks rules, but generally may not take into account detailed shade measurements. The exact location of modules within the specified regions may not be specified in the permit package provided to the AHJ. The specified regions may be significantly larger than the area needed to fit the maximum number of modules. In general the specified regions may include all viable locations for modules on the roof taking into account code requirements.

In contrast to conventional methods of designing and installing PV systems in which the module equipment and layout, and an accurate energy forecast are established prior to submitting a permit and prior to beginning installation, in one embodiment of the present disclosure, a detailed description of equipment, module layout, and an accurate forecast of the system energy production may not be established until during or after installation. Removing the need for a system description prior to beginning the installation may eliminate the need for a site survey prior to system design, and thus, may eliminate the need for personnel to get on the roof prior to installation. All of the pre-installation work may be done during, for example, a sales visit, or remotely using modest resolution aerial imagery, such as those available from Google® maps having, for example, one (1) foot per pixel resolution.

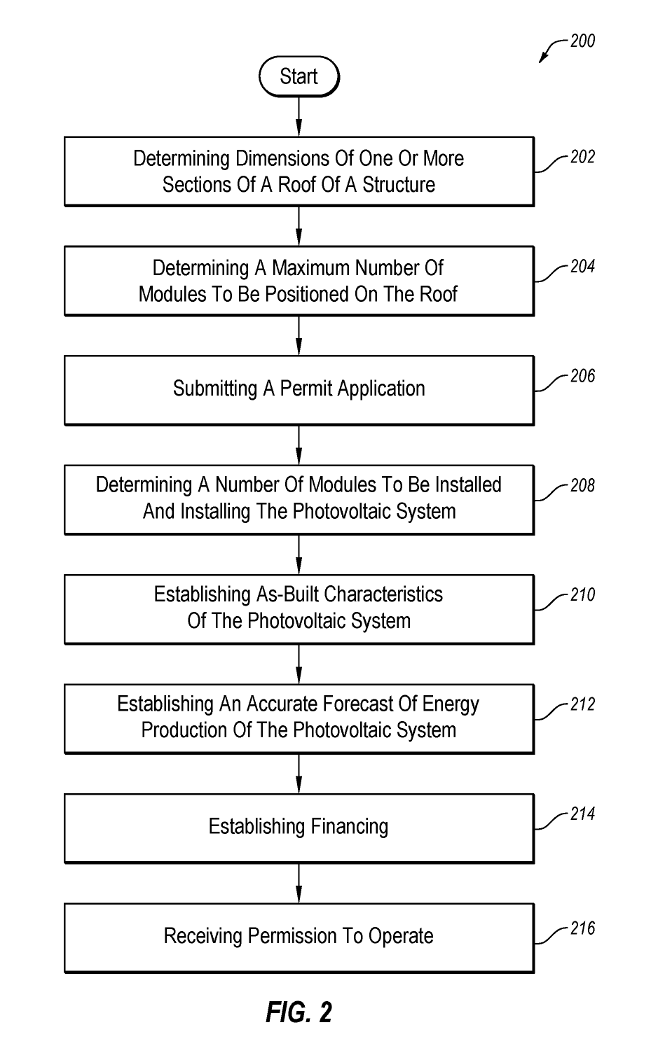

FIG. 2 is a flowchart depicting a method 200, according to an embodiment of the present disclosure. Method 100 includes various acts that may be performed during installation of a PV system. It is noted that although the acts of method 200 are presented in a specific order, the present disclosure does not require that the acts be performed in the disclosed order, or any other sequential order. Rather, the acts described herein may be performed in any suitable order, as will be appreciated by a person having ordinary skill in the art. It is further noted that method 200 does not require each disclosed act for performing a PV installation process.

Initially, method 200 may include determining approximate dimensions of one or more sections of a roof of a structure (e.g., a house) at a job site (depicted by act 202). As an example, the approximate dimensions may be determined remotely using aerial imagery. It is noted that during act 202, it is only necessary to determine if a minimum number of modules will fit on the roof to make the project financially viable. Further, as an example only, act 202 may occur during a sales phase (i.e., similar to act 102 shown in FIG. 1) by sales personnel. Further, it may be desirable, during the sales phase, to determine and confirm that the minimum number of modules can be accommodated at the job site. This may require some assessment of shading at the job site through, for example, aerial imagery, or in cases where there is some doubt, through other means. In some cases, oblique imagery (e.g., via Bing® Bird's Eye view) or street view imagery (e.g., via Google® Street View) may provide an indication of shading from trees at the job site. In other cases (i.e., possibly a small percentage of job sites), a visit to the job site to photograph the roof and surrounding shading structures and trees, without going on the roof, may be required. However, this may comprise a relatively short site survey visit and, hence, may not significantly add to the project costs. Further, in a fraction of the cases, it may be determined during installation that the minimum number of modules cannot be accommodated and, thus, the sale opportunity may need to be abandoned.

Method 200 may further include determining a maximum number of modules to be positioned on the roof (e.g., based at least partially on a rough size of the roof, (e.g., as determined from aerial imagery)) (depicted by act 204). Further, the maximum number of modules may be determined by taking into account any roof penetrations, obvious shading, and/or the energy usage of the end customer (i.e. homeowner). Potential roof areas (i.e., to position one or more modules) may be defined based on various rules, such as code, set-back rules, and shade.

The potential roof areas may have a priority assigned to them. For example, roof sections with the highest insolation (e.g., south facing) or financial benefit (e.g., west facing or some other orientation that maximizes insolation at specified times corresponding with time of-use rate plans) may be prioritized to be populated with modules first, then other sections (e.g., east facing), and then other sections (e.g., north facing), etc. until the maximum number of modules is reached. This prioritization may indicate a rough starting layout. However, the precise number and locations of modules that will actually be installed does not need to be specified, only a maximum target number and the desired and potential areas for the modules. The specified area can be made larger than needed for the maximum number of modules by a percentage (e.g., 50%), to allow for flexibility in locating modules at install time based on various factors, such as shade or roof penetration limitations. Further, a rough estimate of the minimum energy forecast can be made and used for an initial financing tranche. This estimate could use the minimum module number, along with a conservative shading derate factor, such as, for example only, 75%. Method 200 may further include submitting an expedited permitting package (depicted by act 206). A permitting package, which may be submitted to an AHJ, may include the maximum number of modules to be installed and the sections of the roof where modules may be installed. Typically the limitations imposed by the maximum number of modules, including the additional weight of the PV system exceeding the roof loading maximum, may not preclude obtaining a permit.

Moreover, method 200 may include determining a final number of modules (depicted by act 208) and the location of the modules, and potentially the specific type of modules and, possibly, specific type of electronics. Method 200 may also include installing the PV system including the modules. For example, an installation crew may determine the final number of modules and the location of the modules. At least as many modules as the minimum determined in the pre-sale analysis and no more than the maximum determined in the design phase will be installed. Further, the optimal number of modules within this range and the specific locations based on preferred roof sections priority, roof penetrations, shade, etc. may be determined. In one embodiment, shade at one of the proposed locations from the design phase may be measured (e.g., using a SunEye provided by Solmetric Corp.). If the solar access is less than a certain threshold, a module may be positioned elsewhere or deleted entirely from the design. In addition, the types of modules and/or module electronics to be installed and the position thereof may be determined. In some cases, certain kinds of equipment may be installed on certain areas of the roof and other kinds of equipment may be installed on other areas based on shade or other site specific attributes. In one embodiment, the “Sun Hours” (i.e., kWhAC/kWDC) may be maximized by selecting module locations, a number of modules, and equipment type.

In another embodiment, step 204 may not be required. In this case, there may not be a maximum number of modules established and there may not be potential roof areas established prior to installation. In this case, there may not be a permit package submitted, or the permit package may not include the maximum number of modules or the potential roof areas and may. For example, the permit package may include only the address of the site and a permit fee. In another example, the permit package may include one or more of an estimate of the number of modules, an estimate of the total power (kWh) of the system, and an estimate of the cost of the system. In this embodiment, the installation crew, once on site, determines the locations of modules based, for example, on the available areas, penetrations, shade, and code requirements.

Method 200 may also include establishing as-built characteristics of the PV system (depicted by act 210). As one example, a description of the as-built equipment and module layout may be generated during installation or after installation is complete. In one embodiment, this may include the precise locations of each module. In another embodiment, the precise location of each module may never be necessary as long as the shading on the modules is measured, as noted below. As another example, as-built shade measurements may be made near one or more PV modules or arrays (i.e., including one or more modules) after installation is complete. A measurement device (e.g., SunEye provided by Solmetric Corp.) may be used to measure the corners of one or more as-built PV arrays or, alternatively, the centers or outer corners of each PV module. The measurement device would typically be positioned on the upper surface of the modules. Measuring the as-built shade may result in a more accurate estimate of the shading of the PV arrays than a conventional method, which may include measuring the corners of the roof prior to installation in the traditional site survey (i.e., because the location of the PV modules are not known at the time of a pre-design site survey). More accurate shade measurements may lead to a more accurate energy forecast, which is valuable in obtaining the lowest cost financing for a project.

Method 200 further includes establishing an accurate forecast of energy production of the PV system (depicted by act 212). For example, the forecast may be made based on the as-built characteristics (e.g., using one or more of the as-built equipment, as-built module locations, and as-built shade measurements). This can be done, for example, using software such as the PV Designer software from Solmetric Corp. Such software uses the system characteristics along with historical regional weather information and solar simulation algorithms to forecast energy production. The forecast may then be used to establish the final financing of the project. In a case wherein one or more tranches have already been released, a subsequent tranche can “true-up” the overall financing to match the new, more accurate energy forecast. Method 200 may further include establishing financing (depicted by act 214) and receiving PTO (depicted by act 216).

As will be appreciated, embodiments of the present disclosure may ensure that the only time an individual gets on a roof is during the physical installation of one or more PV modules, followed by the post-installation module layout annotation and the shade measurements, which preferably happen during the same site visit as the installation. Since an installer (e.g., of the installation crew) must get on the roof to install the modules, he/she must be covered by Workman's Compensation insurance that includes roof work and he/she must use safety precautions, including anchors and harnesses.

Embodiments of the present disclosure, which are directed to methods of designing, installing, and forecasting PV systems, have the potential to save as much as $750 per PV system or $0.12 per installed Watt, reduce the risk of injuries (e.g., due to falling), and increase the accuracy of energy production forecasts. More accurate energy production forecasts may narrow the distribution of fleet performance relative to forecast, and has the potential to reduce the cost-of-capital (e.g., by lowering the perceived risk to financing institutions) and to reduce the cost of operations and maintenance.

According to one embodiment, a financing tranche may be paid following establishing the maximum number of modules and the potential roof areas and based on initial rough energy forecasts, and later tranches may be used to “true-up” to account for corrections in the forecast based on the as-built system. This may have an advantage of improving the cash flow of an installation company (e.g., because it receives money up front to pay for the equipment being installed). In another embodiment, no financing tranches are paid until after the as-built system is established. This may have an advantage of not requiring a true-up. In another embodiment, the true-up is done later (e.g., 6 months or a year or another time period) after PTO based on the actual energy produced (e.g., as measured by an on-site energy meter). Actual weather is normally the risk of the financier, not the installer; therefore, in this case the energy is normalized to account for the actual weather. This may have an advantage of producing a more accurate analysis of the actual performance of the PV system. In another embodiment, the true up may happen with a different project. Most financing partners may finance many PV systems, which may provide the opportunity to true up over time across a number of PV systems.

If the service panel is outdated or not rated to handle the inverter current, it may be upgraded or the project may be cancelled. The upgrade may be expensive (e.g., $500). Typically during a traditional site survey, a technician may open a service panel and analyze it to determine if an upgrade is necessary. Similarly, if the roof (e.g., shingles) is in poor condition, then it may be replaced or the project may be cancelled. Typically during a conventional site survey, a technician may climb on the roof and walk over the major surfaces of the roof feeling for squishy sections and looking for failing shingles. Similarly, if the roof has structural problems (e.g., the rafters are cracked), then it may be repaired or the project may be cancelled. During a conventional site survey, the technician may climb into an attic and inspect the rafters and sheathing. If any of these three problems (i.e., service panel, roof surface, and structural) are not discovered until the installation team arrives, the consequences are expensive because the entire team must go home or the repairs/upgrades must be made at a cost that may not have been accounted for originally. For this reason, the service panel, roof condition, and structural condition are typically inspected during the traditional site survey.

There are a number of embodiments that address this in the case where there is not a traditional site survey. In one embodiment of the present disclosure, in which there is no site survey, a best-effort and statistical risk/benefit balancing method may be used to handle these challenges. For example, in 10% of solar installations in California the service panels are upgraded. Of these, perhaps, half can be identified without opening the panel by considering the age of the house and/or the region where the house resides. Still more can be identified by the sales person photographing the outside of the panel and showing it to an electrician off-site. In this way, the number of systems that need a panel upgrade that was not identified before installation time can be reduced to a low percentage (e.g., to 1% or less). Hence, 1% or less of systems may get cancelled at installation time, which is still very costly for the 1%, however, the savings associated with analyzing the condition of the service panel remotely except for photographs taken by the sales person (i.e. there was no site survey and so the service panel was never opened up to inspect) may out-weight the low probability/high cost event. Alternatively, a traditional site survey may be performed for sites in which the service panel cannot be adequately evaluated by the sales person or remotely. This will typically be a small number of systems.

In another example, a low percentage (e.g., 5%) of roofs in which solar is otherwise desired in California are in poor condition and, therefore, may require re-roofing or the project may be cancelled. Without a site survey, a certain percentage (e.g., 80%) of these can be identified by, for example, a sales person photographing the roof either from the ground or from a ladder, or with a camera on a pole and showing photographs to an off-site roof expert. The remaining (e.g., 1%) may be discovered at install time at a severe cost (e.g., for the 1%), but again it may be beneficial to accept this low probability, high cost event in light of the other costs savings of eliminating the site survey. Alternatively, a traditional site survey may be performed for sites in which the roof condition cannot be adequately evaluated by the sales person or remotely. This will typically be a small number of systems.

In another example, a percentage (e.g., 2%) of roofs in which solar is otherwise desired in California have structural problems and therefore require structural repair (e.g., repairing rafters) or the project will be cancelled. Without a site survey, a certain percentage (e.g., 50%) of these can be identified by the sales person and remote expert structural review, for example, by considering whether the house was permitted when originally built, whether there has been any structural changes to the roof since then, and whether there is more than a single layer of shingles on the roof. For example, houses in California are, by code, required to structurally support up to two layers of composite shingles. A layer of composite shingles is more weight per square foot than a PV system. Therefore, if there is only a single layer, there may not be a structural weight problem. The remaining percentage (e.g., 1%) may be discovered at install time at a severe cost (e.g., for the 1%), but again it may be beneficial to accept this low probability, high cost event in light of the other costs savings of eliminating the site survey. Alternatively, a traditional site survey may be performed for sites in which the structural condition cannot be adequately evaluated by the sales person or remotely. This will typically be a small number of systems.

According to various embodiments, a conventional site survey may be completely eliminated with only remote analysis of aerial imagery and building information used. In another embodiment, an abbreviated site survey is performed in which the technician does all the same tasks as a traditional site survey without getting on the roof. The technician may climb up a ladder but not get on the roof. This may eliminate the need for a safety harness and anchor and gives the ability to inspect the roof from the eave, take shade measurements at the eave, and take photos of the roof from the eave. Aerial imagery may be used to measure roof dimensions and roof penetrations. The photos taken by the technician may provide additional detail not seen in the aerial imagery. Photogrammetry may utilize these photos along with the aerial imagery to extract three-dimensional (3D) information such as vent pipe or chimney heights. With 3D data shading can be extracted at locations on the roof other than at the eaves where the photos were taken. For example, shadows can be simulated in a 3D CAD system, such as Sketch-Up owned by Trimble Navigation of Sunnyvale, Calif.

In another embodiment, an abbreviated site survey is performed in which the technician does all the same tasks as a traditional site survey, except the technician may not be required to get on the roof or a ladder. This may eliminate the need to drive a vehicle to the site capable of carrying a ladder. In this case, the technician may take photos using a camera on a pole. This can be done, for example, with a SunEye on an extension platform and pole and/or a camera, such as a GoPro® camera from GoPro Inc of Sunnyvale, Calif. In another example, the photos may be captured using a flying drone, such as a DJI Phantom drone sold by DJI of Shenzhen, China. In general, photos may be captured without climbing a ladder or getting on the roof. The photos can then be analyzed to estimate the roof condition. The photos may provide additional detail not seen in the aerial imagery. Photogrammetry may utilize these photos along with aerial imagery to extract 3D information such as vent pipe or chimney heights. With 3D data, shading can be extracted at locations on the roof other than at the eaves where the photos were taken. For example, shadows can be simulated in a 3D CAD system such as Sketch-Up owned by Trimble Navigation of Sunnyvale, Calif.

As discussed herein, a roof (e.g., a residential roof) may be evaluated (e.g., for a new solar installation) by climbing on the roof using a ladder and a harness (e.g., a fall protection harness). Further, a tape measure may be used to measure roof dimensions and roof penetrations (e.g., vent pipes and chimneys) and a hand-held tool may be used to measure shading. Paper and pen may be used to record measurements. This process may take approximately 1-2 hours. Transporting a ladder to a site usually requires a large vehicle (e.g., a truck).

In addition, for safety purposes, an anchor, which attaches to the roof near the ridge line, may be required. The anchor may put holes in the roof that should be patched when a survey is complete. Ascending to the ridge to attach the anchor and descending after the anchor is removed are un-protected activities that carry a risk of injury. Furthermore, in climates that have snow and ice, climbing on a roof may be dangerous, if not impossible.

One example hand-held shade tool is the SunEye-210 provided by Solmetric Corp. The SunEye-210 uses a fisheye camera to measure the shade. The SunEye-210 may require that a user climb on a roof and hold the device on a roof, and it may not provide information about roof dimensions. Other tools have similar limitations.

A number of companies have developed cloud-based software tools that use aerial imagery to measure roof dimensions, and in some cases model shading. The tools may use oblique aerial images to create 3D models of a roof and shade-causing obstructions near the roof. These tools may suffer from basing their measurement results entirely on overhead aerial imagery captured by low-flying aircraft or satellites. However, the resolution and availability of aerial imagery varies dramatically across different regions of a geographical area (e.g., the United States). While many cities have good imagery, many suburbs and rural areas do not. Typical aerial imagery has 4-6″ pixels, which may not be adequate to resolve vent pipes or gutters or to inspect the quality of shingles. Furthermore, aerial imagery of a particular region is typically collected every 1-4 years, so new construction and tree growth may not be captured in the images. For these reasons, installation companies typically use these tools only during a sales process. Once a sale is made, the solar installer may visit the site to make physical measurements, as described above. Various embodiments of the present disclosure may improve the site survey process by eliminating the need to climb on a roof as part of the site survey of a solar project or in general any time other than when the actual solar equipment is being installed on the roof.

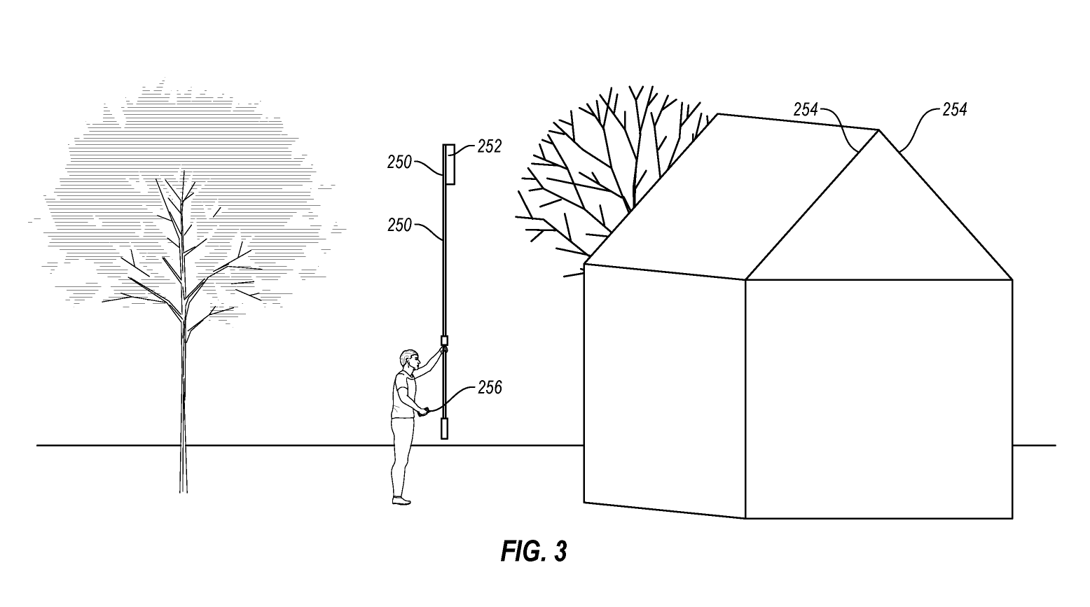

Various embodiments of the present disclosure may eliminate a need for a ladder, truck, fall protection, and/or getting on a roof prior to actual installation of a solar system equipment. One embodiment may include utilizing a camera (e.g., spherical camera) coupled to a pole (e.g., a collapsible fiberglass pole), an electronic device (e.g., a smartphone), aerial imagery, and cloud software. FIG. 3 illustrates a pole 250 including a camera 252 coupled thereto and positioned proximate a structure 254. FIG. 3 further illustrates an electronic device 265.

This embodiment may enable site survey technicians to measure solar potential of a structure (e.g., a house) without climbing on the roof of the structure prior to installation, dramatically improving safety and efficiency. In operation, pole 250 may be extended from ground level positioning camera 252 above the roof eaves. Images may be captured at different locations around the outside of structure 254 that are reachable with pole 250. For example, pole 250 may be positioned every ten feet along the roof eave and/or along the rakes or spans of the roof. Camera 252 may be triggered via software on electronic device 256 that is in communication (e.g., wireless communication) with camera 252. Captured images may be processed to determine roof dimensions, shade, and penetrations.

It may be necessary to know the orientation of camera to know the trajectories of the sun in an image and, hence, the extent of shadows. In one example, the tilt of the camera may be measured with an inclinometer (e.g., on the camera). A weakness of traditional shade measurement devices is that they may use a magnetic compass to determine the azimuth orientation of the camera. A magnetic compass is error prone due to interference from nearby ferromagnetic material, such as iron pipes or nails in the roof. In one embodiment of the present disclosure, the azimuth angle of the camera may be determined without using a compass. The upper hemisphere of the spherical camera may be used to measure the shade while a section of the lower hemisphere may be used to view the roof edge or shingles. The azimuth orientation of the camera may be determined by correlating a roof edge in the section of the lower hemisphere image with a roof edge in an aerial image. The orientation of the roof edge in the aerial image may be known because the aerial images are georeferenced.

A spherical camera, in addition to enabling the shade measurement, may also provide high resolution images of aspects of the roof that cannot be seen in aerial imagery. For example, an image may be used for the purpose of evaluating a condition of the roof. For example, one reason this is important is because installation companies typically do not want to install solar modules on a roof that has old shingles. The high resolution images also may show narrow or small features of the roof, such as gutters and vent pipes. These are important because modules typically cannot be installed in these locations.

By taking multiple images of the same roof penetrations (e.g., vent pipes or chimneys) from different locations around the roof, a height of the penetrations may be determined using known stereoscopic techniques. These heights may be used to further analyze shading. In general, when multiple observations are made of a particular roof feature, including roof plane vertices, a 3D model of the roof and features may be created. The multiple views may come from a combination of images from the camera on the pole, aerial images, and images taken from ground level.

In one embodiment, a pole (e.g., pole 250) may be collapsible (e.g., to enable it to fit inside a car). Plus the elimination of the need for a ladder, may eliminate the need for a site survey technician to drive a large vehicle (e.g., a truck) to the site. Instead, a smaller, lower cost vehicle may be used. Overall, avoiding getting on a roof represents a significant reduction of expense and risk. Furthermore, integrated software may reduce user data entry errors associated with pen and paper by collecting data electronically and transmitting it to a server.

Once the roof is measured, the minimum and/or maximum number of modules that may fit and/or the potential roof areas may be determined. A permit application may then be submitted.

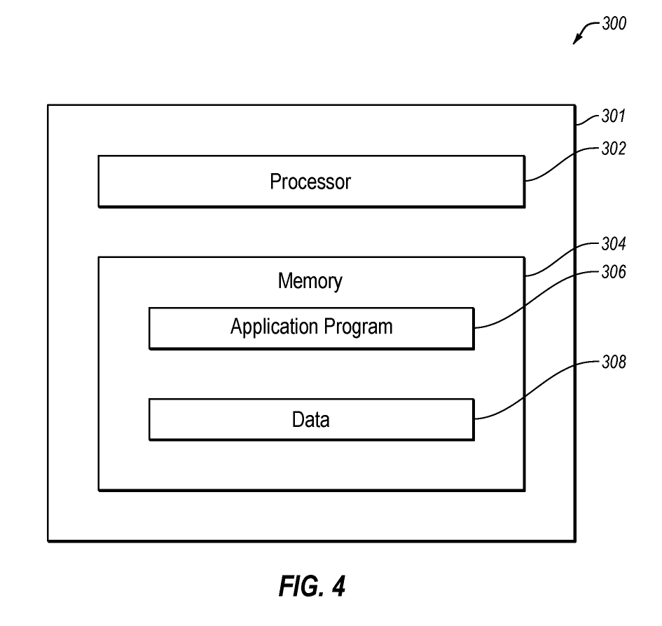

It is noted that various acts of the methods described herein may be at least partially automated (i.e., performed with the assistance of one or more electronic devices). FIG. 4 is a block diagram illustrating an embodiment of system 300 including an electronic device 301 comprising a processor 302 and memory 304. Processor 302 may comprise any known and suitable processor. Memory 304 may include an application program 306 and data 308, which may comprise stored data. Application program 306 may include instructions that, when read and executed by processor 302, may cause processor 302 to perform steps necessary to implement and/or use embodiments of the present disclosure. Application program 306 and/or operating instructions may also be tangibly embodied in memory 304, thereby making a computer program product or article of manufacture according to an embodiment of the present disclosure. As such, the term “application program” as used herein is intended to encompass a computer program accessible from any computer readable device or media. Further, application program 306 may be configured to access and manipulate data 308 stored in memory 304 of electronic device 301. In addition, memory 304 may be configured for storing any data (i.e., information) related to a PV system and/or a process of installing a PV system.

Although the foregoing description contains many specifics, these should not be construed as limiting the scope of the disclosure or of any of the appended claims, but merely as providing information pertinent to some specific embodiments that may fall within the scopes of the disclosure and the appended claims. Features from different embodiments may be employed in combination. In addition, other embodiments may also be devised which lie within the scopes of the disclosure and the appended claims. The scope of the disclosure is, therefore, indicated and limited only by the appended claims and their legal equivalents. All additions, deletions and modifications to the disclosure, as disclosed herein, that fall within the meaning and scopes of the claims are to be embraced by the claims.

1. A method, comprising:
determining a maximum number of photovoltaic (PV) modules for positioning on a roof of a structure;
determining one or more regions on the roof for positioning at least the maximum number of PV modules;
submitting a permitting package including the maximum number of PV modules and the one or more regions;
determining a number of PV modules to be installed on the roof, the number of PV modules less than or equal to the maximum number of PV modules; and
installing the number of PV modules within at least one of the one or more regions.

2. The method of claim 1, wherein determining a maximum number of PV modules comprises determining the maximum number of PV modules via aerial imagery.

3. The method of claim 1, wherein determining a maximum number of PV modules comprises determining approximate dimensions of the roof.

4. The method of claim 1, further comprising determining a minimum number of PV modules that may be positioned on the roof.

5. The method of claim 4, further comprising determining if a PV system including the minimum number of PV modules is financially viable.

6. The method of claim 4, wherein determining a minimum number of PV modules comprises determining the roof area via aerial imagery.

7. The method of claim 6, wherein determining a minimum number of PV modules comprises evaluating shading of the roof.

8. The method of claim 1, wherein determining a number of PV modules to be installed on the roof comprises determining the number of PV modules to be installed on the roof after submitting the permitting package.

9. A method of installing a photovoltaic (PV) system, comprising:
receiving a permit based on a determined maximum number of photovoltaic (PV) modules to be positioned on a roof of a structure and one or more regions on the roof for positioning at least the maximum number of PV modules;
evaluating the suitability of various locations for PV modules within the regions;
determining a number of PV modules to be installed on the roof, the number of PV modules less than or equal to the maximum number of PV modules; and
installing the number of PV modules within at least one of the one or more regions.

10. The method of claim 9, further comprising:
determining the maximum number of PV modules of the photovoltaic system; and
determining the one or more regions on the roof for positioning at least the maximum number of PV modules.

11. The method of claim 9, further comprising:
establishing an accurate energy forecast of the PV system after installing the PV system; and
determining at least part of the financing of the PV system based on the accurate energy forecast.

12. The method of claim 9, further comprising submitting a proposal for the permit based on a determined maximum number of PV modules to be positioned on a roof of a structure and one or more regions on the roof for positioning at least the maximum number of PV modules.

13. The method of claim 9, wherein evaluating the suitability of various locations for modules within the regions comprises evaluating shading proximate the structure.

14. The method of claim 9, further comprising establishing the as-built characteristics of the PV system.

15. The method of claim 14, wherein establishing the as-built characteristics of the PV system comprises estimating the shading of one or more of the installed PV modules.

16. The method of claim 14, further comprising establishing an accurate energy forecast of the PV system based on the as-built characteristics; and establishing financing for the PV system based at least partially on the accurate energy forecast.

17. A method, comprising:
determining a minimum number of photovoltaic (PV) modules for the PV system;
determining a maximum number of PV modules of a PV system to be positioned on a roof of a structure;
determining one or more regions on the roof for positioning at least the maximum number of PV modules;
submitting a permitting package including the maximum number of PV modules and the one or more regions;
installing the PV system including a number of PV modules less than or equal to the maximum number of PV modules and greater than or equal to the minimum number of PV modules and within at least one of the one or more regions; and
establishing an accurate energy forecast of the PV system after installing the PV system.

18. The method of claim 17, further comprising determining the number of PV modules to be installed on the roof.

19. The method of claim 17, wherein each of the determining a minimum number of PV modules, the determining a maximum number of PV modules, and the determining one or more regions is completed without requiring a human to set a foot on the roof.

20. The method of claim 17, wherein determining one or more regions comprises determining the one or more regions based on at least one code requirement.
